(19) United States
(12) Patent Application Publication
(10) Pub. No.: US 2015/0019278 A1
(43) Pub. Date: Jan. 15, 2015

(54) SYSTEM AND METHOD TO HANDLE REQUESTS FOR ACCOMMODATIONS VIA A LEAVE MANAGEMENT SYSTEM

(71) Applicants: Kimberly K. Belval, Wolcott, CT (US); Tawnya D. Goertzen, Saint Michael, MN (US); Christopher W. Lancaster, Dayton, MN (US); Norine K. Wilcox, Eagan, MN (US)

(72) Inventors: Kimberly K. Belval, Wolcott, CT (US); Tawnya D. Goertzen, Saint Michael, MN (US); Christopher W. Lancaster, Dayton, MN (US); Norine K. Wilcox, Eagan, MN (US)

(21) Appl. No.: 13/938,528

(22) Filed: Jul. 10, 2013

(51) Int. Cl. G06Q 10/06

(52) U.S. Cl. CPC G06Q 10/063116
USPC 705/7.16

(57) ABSTRACT

According to some embodiments, data received via a communication device indicative of employee claims, including employee claims for one of a plurality of types of employee leave, may be processed. It may then be detected that a particular employee claim is associated with a request for accommodation. It may be automatically determined if medical information associated with the request for accommodation meets predetermined criteria, and an indication of said determination may be transmitted.

### BACKGROUND

In some cases, an employee may request that an employer provide a workplace accommodation. For example, an employee with a physical or mental disability might ask an employer to provide special equipment or modify a work schedule because of his or her impairment. Moreover, governmental laws and regulations, as well as employer specific policies, might need to be considered when an employer responds to such a request. The Americans with Disabilities Act (“ADA”) Amendment Act (“ADAAA”), for example, requires an employer to provide reasonable accommodations to employees in the absence of an undue hardship to the employer. When considering a request for accommodation, an employer may need to review a number of factors, including an employee's medical records and the essential functions of the employee's job, in a timely fashion.

As a result, responding to a request for accommodation in an appropriate manner can be a complex and time-sensitive task and can be especially difficult when there are a substantial number of employees and/or requests to be considered. It would therefore be desirable to provide systems and methods to facilitate the processing of employee requests for accommodations in an automated, efficient, and consistent manner.

### SUMMARY OF THE INVENTION

According to some embodiments, systems, methods, apparatus, computer program code and means may provide a tool to facilitate the processing of requests for accommodations. For example, data received via a communication device indicative of employee claims, including employee claims for one of a plurality of types of employee leave, may be processed. It may then be detected that a particular employee claim is associated with a request for accommodation. It may be automatically determined if medical information associated with the request for accommodation meets predetermined criteria, and an indication of said determination may be transmitted.

Some embodiments provide: means for processing data, received at a leave management system platform, indicative of employee claims, including employee claims for one of a plurality of types of employee leave; means for detecting that a particular employee claim is associated with a request for accommodation; means for automatically determining if medical information associated with the request for accommodation meets predetermined criteria; and means for transmitting an indication of said determination.

A technical effect of some embodiments of the invention is an improved and computerized method to facilitate the processing of requests for accommodations. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 is a flow diagram illustrating a method that might be performed in accordance with some embodiments.

FIG. 3 is a schematic diagram of an exemplary computer network for implementation of embodiments of a method and system of the invention.

FIG. 4 illustrates an employee advocate flow diagram in accordance with some embodiments.

FIG. 5 illustrates an employee advocate coordinator referral and action process according to some embodiments of the present invention.

FIG. 6 illustrates a process that might be performed when no claim or leave event is submitted according to some embodiments of the present invention.

FIG. 7 illustrates an on-site support process according to some embodiments of the present invention.

FIG. 8 is a schematic diagram of exemplary network components for a computer system.

FIG. 9 is a schematic diagram illustrating a computer network and system in accordance with some embodiments of the invention.

FIG. 10 is a schematic diagram illustrating a computer system for implementing an embodiment of the invention in a network.

FIG. 11 is a schematic diagram illustrating a system including a handheld wireless device for implementing an embodiment of the invention.

FIG. 12 is block diagram of a leave management system tool or platform according to some embodiments of the present invention.

FIG. 13 is a tabular portion of a request for accommodation database according to some embodiments.

FIG. 14 illustrates a computer display in accordance with some embodiments described herein.

### DESCRIPTION

Employers may receive requests for accommodations from employees who have physical or mental disabilities. As used herein, a request for accommodation might be associated with, for example, a change to a work environment such as by making existing facilities readily accessible to and usable by an individual with a disability, job restructuring, part-time or modified work schedules, telecommuting, reassignment to a vacant position, acquisition or modification of equipment or devices, appropriate adjustment or modifications of examinations, training materials or policies, the provision of qualified readers or interpreters, and/or other similar accommodations for employees with disabilities.

When considering a request for accommodation, an employer may need to review a number of factors, including an employee's medical records and the essential functions of the employee's job, in a timely fashion. As a result, responding to a request for accommodation in an appropriate manner can be a complex and time-sensitive task and can be especially difficult when there are a substantial number of employees (e.g., tens of thousands employees) and/or requests to be considered.

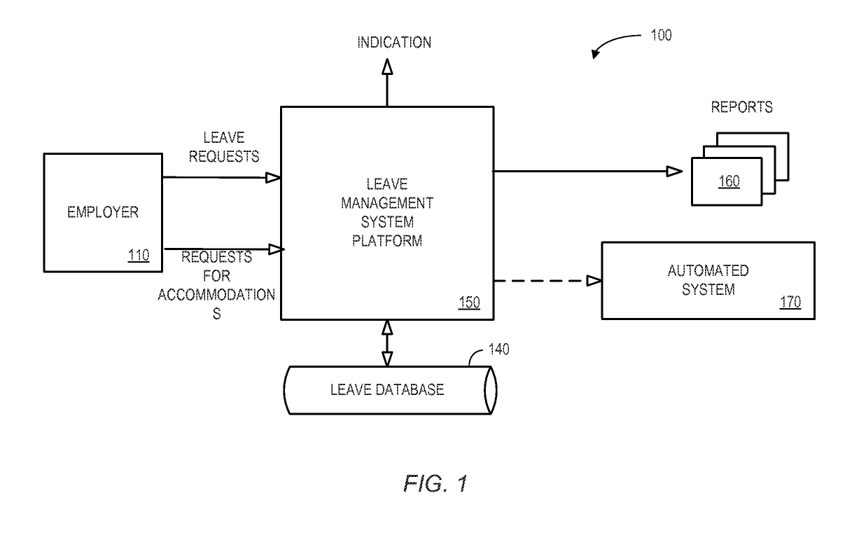

It would therefore be desirable to provide systems and methods to facilitate the processing of requests for accommodations in an automated, efficient, and consistent manner. FIG. 1 is block diagram of a system 100 according to some embodiments of the present invention. In particular, the system 100 includes a leave management system platform 150. Note that an employer 110 may typically have policies and plans that address employee time away from work. For example, the employer 110 may be required to provide workers' compensation coverage for employees who incur job-related illnesses or injuries. The employer 110 may also have policies for sick leave for relatively short periods of illness, such as up to two weeks, short term disability leave for non-occupational illnesses or injuries for periods longer than the period of sick leave and of up to generally 90 or 180 days, and long term disability plans that provide income benefits after an elimination period generally of 90 or 180 days. In addition, the Federal Family and Medical Leave Act (“FMLA”) might apply to the employer 110 and provide eligible employees with job-protected leave for certain family or medical reasons.

Most states also have one or more leave laws with which the employer 110 must comply. Determining requirements and tracking requirements for all of the different types of mandated leave can be a complex task for the employer 110. As a result, the employer 110 might transmit information about leave requests to the leave management system platform 150 (e.g., associated with an insurer) which can review the leave requests and help the employer 110 respond to the leave request appropriately.

According to some embodiments described herein, the leave management system 150 may also help the employer 110 in connection with employee requests for accommodations. The leave management system platform 150 may, for example, receive information about employee claims from the employer 110, including employee leave requests and employee requests for accommodations. According to some embodiments, the leave management system platform 150 may also receive information, such as an electronic message, from a client, an employee or insurance agent, or a leave database 140. The leave management system platform 150 might be, for example, associated with a Personal Computers (PC), laptop computer, an enterprise server, a server farm, and/or a database or similar storage devices. The leave management system platform 150 may, according to some embodiments, be associated with a business organization or an insurance provider.

According to some embodiments, an “automated” leave management system platform 150 may facilitate the processing of requests for accommodations. As used herein, the term “automated” may refer to, for example, actions that can be performed with little or no human intervention. For example, the leave management system platform 150 might detect that a particular employee claim is associated with a request for accommodation. The leave management system platform 150 might also automatically determine if medical information associated with the request for accommodation meets predetermined criteria. For example, it might be determined that additional medical records need to be evaluated. An indication of this determination may then be transmitted (e.g., to an employee, the employer 110, a physician, etc.). The leave management system platform 150 might also generate reports 160 based on the employee claims and/or transmit information to an automated system 170, such as a workflow application or email notification system.

As used herein, devices, including those associated with the leave management system platform 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The leave management system platform 150 may store information into and/or retrieve information from the leave database 140. The leave database 140 may be locally stored or reside remote from the leave management system platform 150. Although a single leave management system platform 150 is shown in FIG. 1, any number of such devices may be included. Moreover, various devices described herein might be combined according to embodiments of the present invention. For example, in some embodiments, the leave management system platform 150 and leave database 140 might be co-located and/or may comprise a single apparatus.

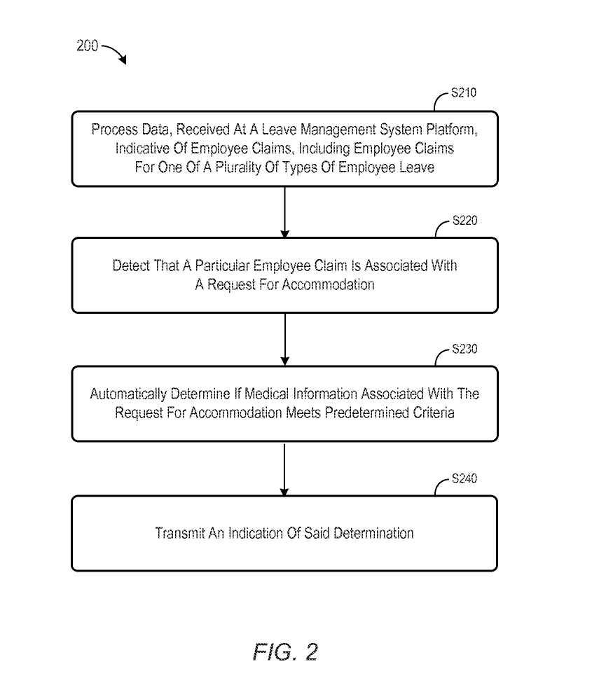

FIG. 2 illustrates a method that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, data received at a leave management system platform is processed. The received data includes employee claims for one of a plurality of types of employee leave. The plurality of types of employee leave may include, for example, workers' compensation leave, short term disability leave, and/or long term disability leave. The leave management system platform may be associated with an insurer, and the data indicative of the particular employee claim may be received from an employer of the particular employee.

At S220, the leave management system platform may detect that a particular employee claim is associated with a request for accommodation. In some embodiments, the particular employee claim is itself a request for accommodation that was submitted by an employee. In other cases, the particular employee claim is instead a leave request and the detecting comprises determining that the leave request satisfies a predetermined rule. For example, in some embodiments the leave management system platform might treat all short term disability leave requests that have a particular International Classification of Disease (“ICD”) code as a potential request for accommodation (e.g., employees requesting short term disability leave for back pain might automatically be considered as requesting a modified chair or desk).

At S230, it is automatically determined if medical information associated with the request for accommodation meets predetermined criteria. For example, the automatic determination might comprise automatically determining that medical information associated with the request for accommodation is insufficient, in which case the leave management platform might automatically request additional medical information. An indication of this determination may then be transmitted at S240. The indication might be transmitted to, for example, an ability analyst, an absence coordinator, an employee advocate, the particular employee, an employer of the particular employee, a job accommodation network consultant, an account manager, a return to work coordinator, a loss control consultant, and/or an attending physician associated with the employee who submitted the request for accommodation. In some embodiments, the leave management platform may further automatically analyze the data indicative of employee claims and provide at least one report that includes a recommended accommodation related adjustment to a workplace environment.

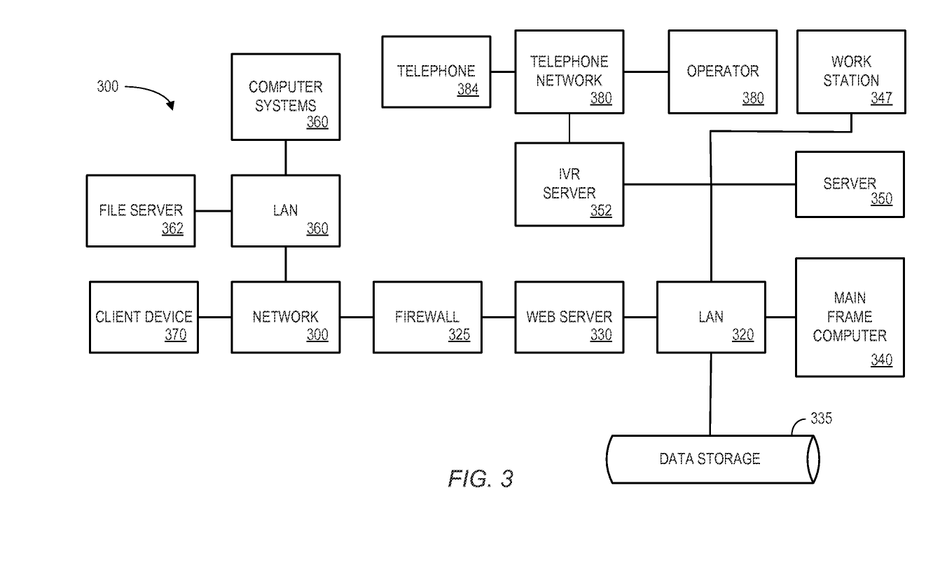

Referring now to FIG. 3, an exemplary network 300 configuration is shown. The network 300 connects various computer systems and devices. The network 300 may be or include any type of network, including a LAN, a WAN, an intranet, the Internet, a PSTN or other network. Various devices and networks may be in communication with the network 300. In some embodiments, client device 370, such as a desktop computer system, a notebook computer system, a tablet computer, or a smart phone, are in communication with the network 300. A LAN 360 is an exemplary network of a business or other employer and is in communication therewith desktop computer systems 360 and a file server 362.

Another LAN 320 may be a network of an insurance company, by way of example. A firewall unit 325 may be configured to provide data security services with respect to systems and networks, LAN 320 and the devices in communication therewith. The firewall unit 325 may be a standalone device including one or more processors, data storage devices, and input and output connections. A server 330 may act as a front-end web server that formats and serves web pages to client devices 370 running browser software. In an embodiment, a processor of server 330 may execute steps of a method of prompting users for data relating to absence events, requests for employee leave, requests for accommodations, and other data employed by comprehensive leave management systems or other systems in accordance with embodiments. In an embodiment, server 330 may function as a web front-end for another device or system, such as server 350, which may execute steps of a method of administering employee absence related programs. In an embodiment, either server 330 or server 350 may serve as a single point of contact for receiving data relating to an absence event or request for accommodation. Mainframe computer system 340 may be a system that receives data from server 350 and performs functions related to managing and tracking absence events. Data storage device 335 may be in communication with LAN 320 and be accessible by server 350, mainframe computer system 340, web server 330 and other systems, for storage of and access to data related to administration of employee leave and requests for accommodations. A workstation 347 may be in communication via LAN 320 with the data storage device 335, mainframe computer system 340, server 350, web server 330, and/or other devices and systems, for administrative and other functions.

In some embodiments, communication between server 350 and individuals, such as employees and employers, may be via a telephone network 380, such as a public switched telephone network, a voice over Internet protocol network, or a combination of a PSTN and VoIP network. By way of example, a fax telephone number may be configured to receive intake data for a new leave event related to two or more categories of employee leave and/or a request for accommodation. Prepared forms may be available for individuals to complete with intake data. The prepared forms may serve as a structured fax format by which data may be transmitted from a fax machine via the telephone network 380 to an insurance company fax machine. Server 350 may be configured to extract data from a digital image (e.g., a fax or emailed pdf file), cause the data to be stored in one or more databases, and perform analytical functions on the data. For example, the server 350 may classify the data according to type of leave, such as short term disability, long-term disability or family and medical leave, and/or requests for accommodations. If the data in the received fax omits required data, contains obvious errors, or otherwise triggers a rule requiring a response, the server 350 may be configured to provide an output in the form of an image file for a responsive fax.

In some embodiments, an Interactive Voice Response system (“IVR”) may be used for the submission of data. A voice telephone 384 may be employed by a user to reach, via telephone network 380, an IVR server 352. The IVR server 352 may prompt the user to provide identification information via voice or keypad, and then prompt the user to provide data corresponding to required data for submission of a new claim related to employee leave, such as employer and employee data, type of leave, request for accommodation information, and other data. The IVR server 352 may communicate with the server 350 (via LAN 320) to analyze data during a telephone connection between IVR server 352 and the telephone 384 and provide instructions for IVR server 352 to generate prompts for additional information, to indicate that data has been received, or to convey other information.

In another embodiment, a system may be configured for initial claim intake to a live telephone operator 380 at a telephone linked via telephone network 380 to a voice phone. The live telephone operator 380 may be at a workstation 347 in communication, such as via LAN 320, to server 350, for example. The system may be configured to generate on a screen of workstation 347 a display of questions for the telephone operator, and a display of an input screen for receipt of data input by the operator. The workstation 347 may be configured to transmit data to server 350 for further processing. The server 350 may be configured to analyze data received from workstation 347 and provide instructions for the telephone operator 380 to address follow-up questions to the other party on the call or to recite one or more scripts including information and/or questions.

In some embodiments, a comprehensive leave management computer system may be configured to perform leave management tracking and coordination and to handle requests for accommodations. A comprehensive leave management computer system may receive intake information and furnish the data to individual administration systems, such as workers' compensation and short term disability administration systems. An individual administration system, such as a workers' compensation system, may process a claim, and data regarding the claim may be furnished to the comprehensive leave management computer system. The comprehensive leave management computer system may also store data relating to the processing of the claim from individual administration systems. The comprehensive leave management computer system may be configured with reporting tools to provide reporting on administration of all types of leave and requests for accommodations.

In some embodiments, the comprehensive leave management computer system may be configured to apply rules relating to coordination among individual leave management systems. For example, if a workers' compensation claim is contested or denied, upon receipt of data indicative of the contest or denial, the comprehensive leave management computer system may transfer data relevant to the claim to a short term disability administration computer system. As workers' compensation claims are generally only approved for occupational injuries, and short term disability claims are only approved for non-occupational injuries or illness, denial of a workers' compensation claim as relating to a non-occupational injury indicates that the employee may have a short term disability claim. By way of further example, if a claim is being handed by the short term disability administration computer system, and a workers' compensation claim for the same incident is approved, the comprehensive leave management computer system may transfer data relevant to the claim to the workers' compensation system, and may provide data to the short term disability administration system to close the claim.

The comprehensive leave management computer system may manage communication with employees, employers, physicians and others. If data or documentation is required relating to a claim, such as a request for accommodation, the individual administration systems may send requests for the information to the comprehensive leave management computer system. The comprehensive leave management computer system may then conduct searches of a database maintained by the comprehensive leave management computer system. The search may include searches of databases maintained by other individual administration systems. The comprehensive leave management computer system may, if the requested information is not identified in any of the databases, formulate an automated inquiry, via any suitable method of communication, including email, postal mail, fax and other methods of communication, to the employee, employer, physician or other person to obtain the requested information. The comprehensive leave management computer system may be configured to prompt an employee to place a telephone call to the employee, employer, physician or other person. Advantageously, duplicative requests for information from physicians, employees and employers may be avoided.

The comprehensive leave management computer system may be configured to provide output signals, to store data, to print reports and otherwise to communicate data indicative of results of performance of analyses and processes. By way of example, the comprehensive leave management system may be configured to provide reports, in printed or electronic form, identifying potential workplace improvements (e.g., to reduce a likelihood of injury to employees). Reports may be generated, stored in data storage devices, forwarded via email, made accessible on web servers or other resources, printed in hard copy, faxed, or otherwise made available for review or stored. Reports may include data as to individual claims, individual employees, summary or complete data regarding employers, worksites, classes of employees of employers, claims suitable for subrogation, and other classifications of data.

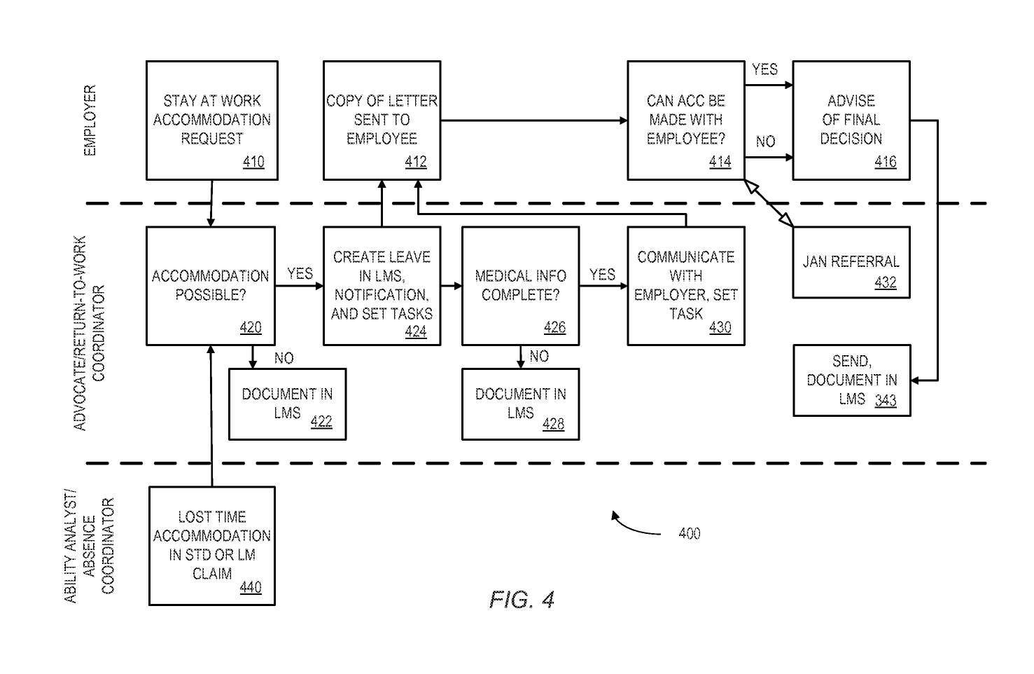

The comprehensive leave management computer system may facilitate the processing of requests for accommodations. For example, FIG. 4 illustrates an employee advocate flow diagram 400 in accordance with some embodiments. In some cases, an employer may process a stay at work accommodation request 410 and provide information to an advocate/return-to-work coordinator. In other cases, an ability analyst/absence coordinator may identify a lost time accommodation from an existing short or long term disability claim 440 and provide information to the advocate/return-to-work coordinator. In either case, if the advocate/return-to-work coordinator determines that accommodations are not possible based on known information 420, a denial of the request may be documented in a leave management system 422 and the process may end. Factors considered by the advocate/return-to-work coordinator might include, for example: the nature and cost of the accommodation; the overall financial resources of the facility or facilities involved in the provision of the reasonable accommodation, the number of persons employed at such facility, the effect on expenses and resources (or the impact of such accommodation upon the operation of the facility); the overall financial resources of the employer (e.g., the size, number, and/or type and location of facilities; the type of operations of the company, including the composition, structure and functions of the workforce; and/or the impact of the accommodation on the operation of the facility.

If the advocate/return-to-work coordinator determines that accommodations may be possible based on known information 420, a leave event may be created in the leave management system, a notification with a medical assessment form may be generated, and appropriate tasks may be created 424 (e.g., in a leave management system). If the medical information is not complete and sufficient 426, information may be documented in the leave management system 428 and the process may end. If the medical information is complete and sufficient 426, the advocate/return-to-work coordinator may initiate further communication with the employer 430.

A copy of a letter sent to the employee may be provided to the employer 412 who can start an interactive process with a Job Accommodation Network (“JAN”) referral 432 to determine if an accommodation can be made with the employee 414. The JAN referral 432 may be associated with services provided by the U.S. Department of Labor's Office of Disability Employment Policy (“ODEP”). The employee may then be advised of the final decision 416, and the result may be documented in the leave management system 428 and the process may end. By leveraging the abilities of an existing leave management system, an efficient processing of requests for accommodations may thereby be provided in accordance with some embodiments.

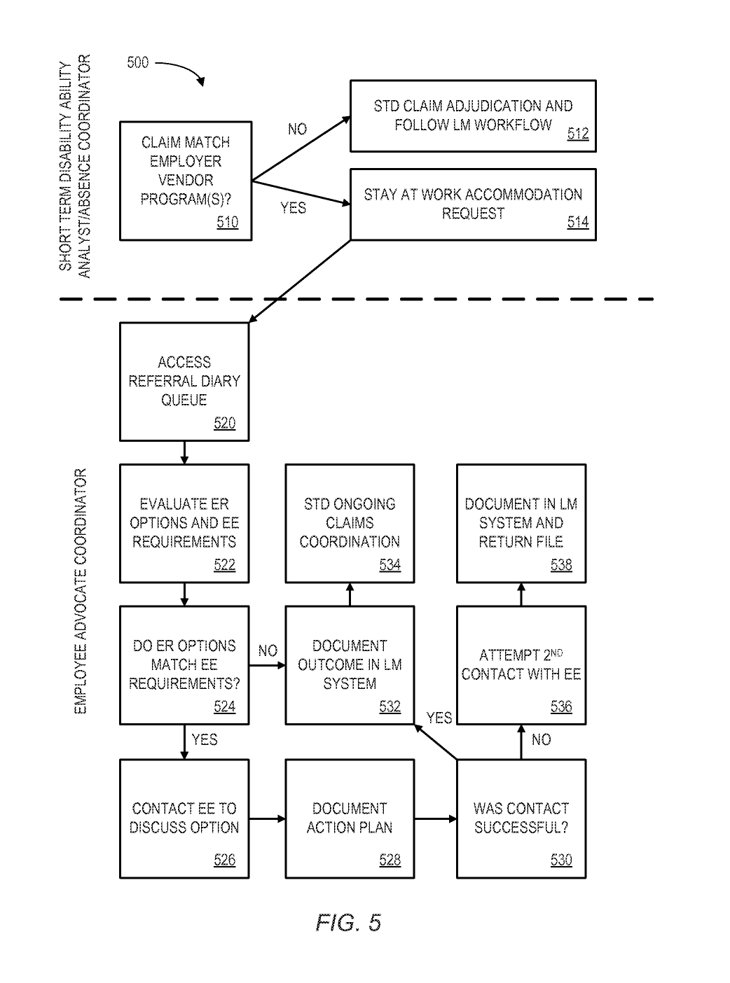

FIG. 5 illustrates an employee advocate coordinator referral and action process 500 according to some embodiments of the present invention. A short term disability analyst/absence coordinator may initially determine if a claim matches one or more vendor programs 510. If not, short term disability claim adjudication 512 may be performed to contact a physician, initiate a medical or behavioral health case management referral, and/or interview the claimant. In addition, a leave management system platform workflow process may be created.

If the short term disability analyst/absence coordinator determines that a claim matches one or more vendor programs 510, the claim may be referred to an employee absence coordinator 514 via a same-day diary and verbal or written consent may be obtained. The employee absence coordinator may access the referral diary queue 520 and/or leave management system (e.g., twice a day) and evaluate employer options and employee requirements 522. If the employer options do not match the employee requirements 522, the outcome is documented in the leave management system 532 and on-going short claims coordination may be performed 534 (e.g., including an evaluation of other clinical disciplines).

If the employer options match the employee requirements 522, the employee is contacted to discuss program options 526, and a vendor contact and follow-up action plan may be initiated and documented 528 in the leave management system as appropriate. If the contact with the employee is successful with the anticipated level of participation 530, the outcome is documented in the leave management system 532 and on-going short claims coordination may be performed 534. If the contact with the employee was not successful 530, a second attempt at contact may be initiated with the employee and/or vendor 536, documented in the leave management system, and the file maybe returned to the ability analyst and/or absence coordinator 538.

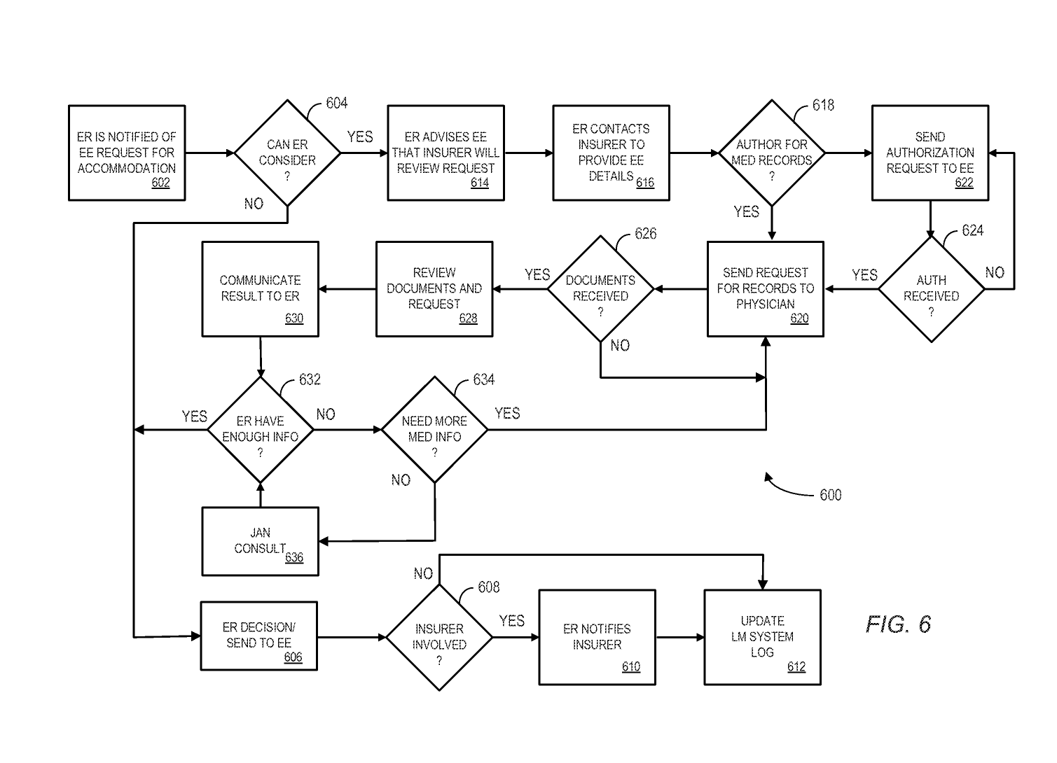

FIG. 6 illustrates a process 600 that might be performed when no claim or leave event is submitted according to some embodiments of the present invention. When an employer is notified of an employee request for accommodation 602, the employer determines if the request is something that can be considered 604. If the request cannot be considered 604, the employer communicates the decision to the employee 606. If an insurer was involved with the request 608, the employer notifies the insurer 610, and a leave management system log is updated 612.

If the request can be considered 604, the employer advises the employee that the insurer will review the request 614, and the employer contacts the insurer to provide employee details 616. If the insurer has authorization to request the employee's medical records 618, a request for the records is sent to the attending physician 620. If the insurer does not have authorization to obtain the employee's medical records 618, an authorization request is sent to the employee 622 and received 624 before contacting the physician 620.

When the medical records are received 626, they are reviewed in relation to the accommodation request 628, and the result of the medical assessment is communicated to the employer 630. If the employer does not have enough information to make a decision 632, additional medical clarification may be received 634 and/or the JAN may be consulted. When the employer has enough information to make a decision 632, the employer communicates the decision to the employee 606. If an insurer was involved with the request 608, the employer notifies the insurer 610, and a leave management system log is updated 612.

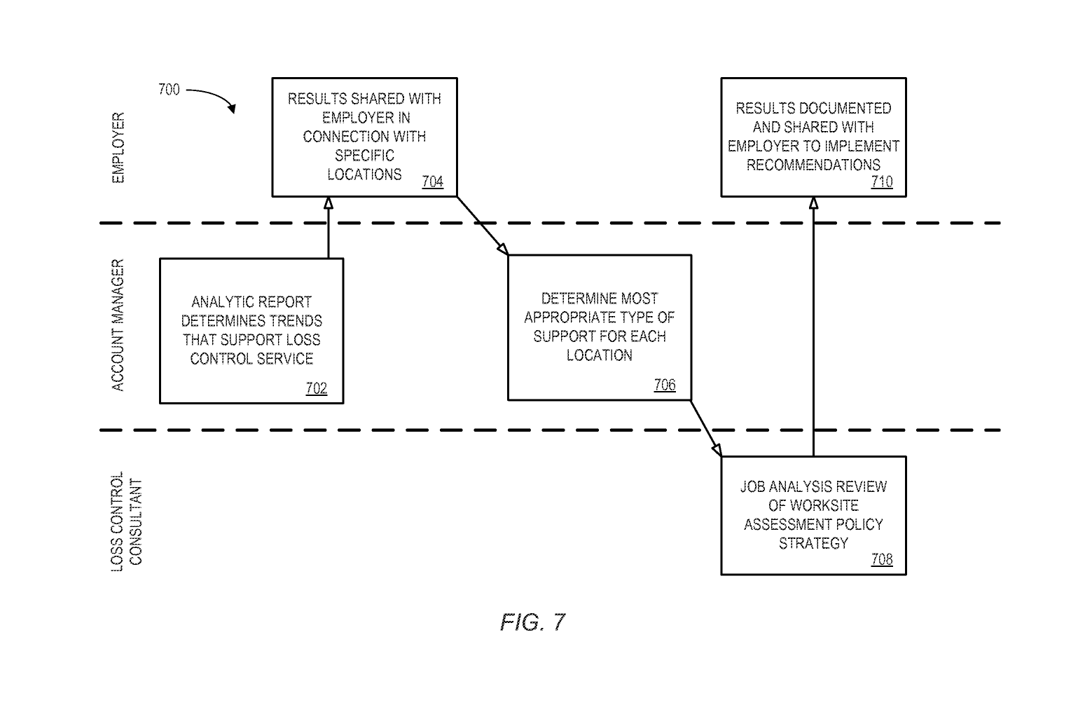

FIG. 7 illustrates an on-site support process 700 according to some embodiments of the present invention. Note that this process 700 is not associated with a specific employee or request for accommodation, but instead is associated with an overall workplace environment. An account manager may initially review an analytic report to determine trends that may support loss control services 702. For example, the account manager might access a leave management system to review an overall number or cost of short or long term disability leave requests along with requests for accommodations over a period of time. When such trends are identified, they may be communicated to an employer with recommendations for onsite support at particular work locations 704. The account manager may determine the most appropriate type of support for each location 706 (e.g., that larger display monitors should be given to employees who regularly perform a certain type of task), and a loss control consultant may coordinate needed services, including a job analysis review of a worksite assessment policy strategy 708. These results may then be documented and shared with the employer 710.

According to some embodiments, a system may be configured to determine, for a given employer, analysis of leave and accommodation requests over a time period, such as one year, a period of months, or a period of years, data including: a frequency of absence under each plan providing for leave, including demographic information regarding users (age, gender, job classification, location, tenure), overlap between plans; changes in absence over time; comparison of absence rates against benchmarks for other businesses in the same industry. The data may also include an average cost of accommodations, in general and on a per plan basis, with changes in cost over time, comparison of cost benchmarks for other businesses in the same industry, identification of outliers or other drivers of higher costs.

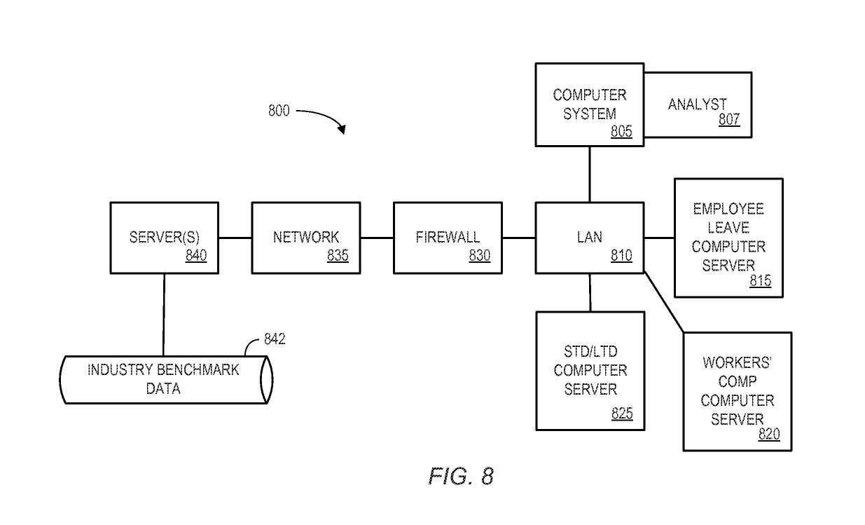

Referring to FIG. 8, in an embodiment, a computer system 805, such as an insurance company computer system, may be operated by an analyst 807. Computer system 805 may include a processor and memory devices having computer-readable media with computer programs having processor executable instructions thereon, which, when executed by a processor, may permit analyst 807 to input instructions for the processor to access data from other insurance company computer systems, such as employee leave computer system 815, workers' compensation computer system 820, and short term/long term disability computer system 825. Employee leave computer system 815 may be configured to receive, analyze, process and store data relating to leave requests and requests for accommodations mandated by applicable law or regulation or employer policies. Workers' compensation computer system 820 may be configured to receive, analyze, process and store data relating to workers' compensation policies of employers insured by the insurance company. Short term/long term disability computer system 825 may be configured to receive, analyze, process and store data relating to short term disability coverage and long term disability coverage of employers insured by the insurance company.

Computer system 805 may also be configured to access, via firewall device 830 and one or more networks 835, which may include Internet, one or more servers 840 controlling access to databases storing industry benchmark data 842. Analyst 807 may cause computer system 805 to retrieve data from industry benchmark database 842. Computer system 805 may retrieve data, perform analyses of the data, and displays on screens and/or on printouts, with tables and graphs.

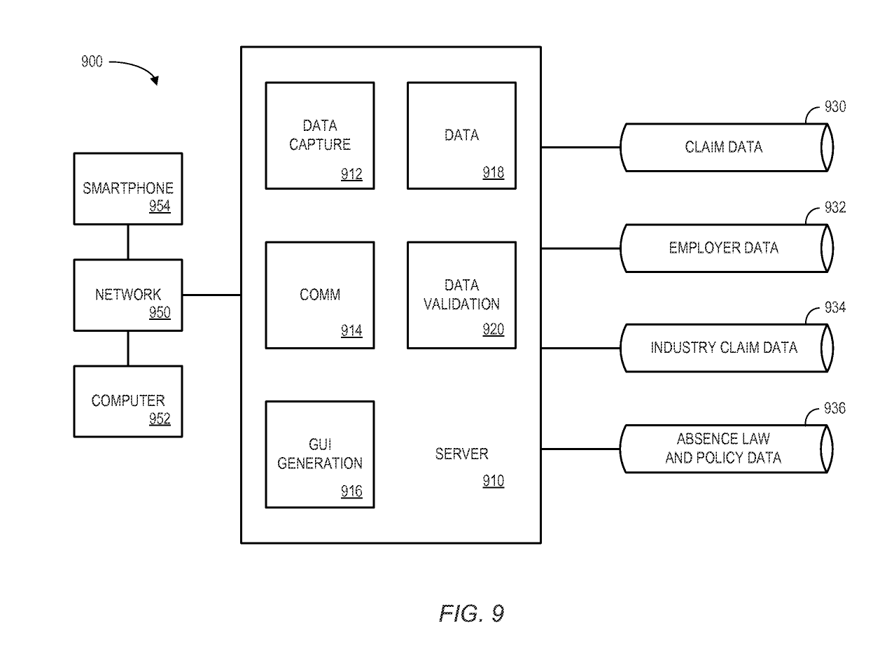

Referring to FIG. 9, another exemplary embodiment of a system 900 of the present invention is shown. System 900 includes a comprehensive leave management server 910 which includes one or more engines or modules which may be utilized to perform one or more steps or functions of the present invention. The term “module,” as used herein, includes computer hardware, including processors and memory devices, having loaded program code causing the processor and other devices to perform particular functions. In an embodiment, the present invention is implemented as one or more modules of a computer software program in combination with one or more components of hardware. Such software programs will be used, for example, when an employer or employee initiates a claim, or makes an inquiry or other request, when another computer system furnishes data to a comprehensive leave management system, when rules implemented by the comprehensive leave management system cause the system to initiate communications, and comprises part of the processing done on the server side of the network. In embodiments, the program will be used in an Internet environment, where the server is a Web server and the inquiry or other request is formatted using HTTP (or HTTPS). One or more functions of a web client or other module may be implemented as application software in the form of a set of processor-executable instructions stored in a memory of a client device, such as smartphone 954, and capable of being accessed and executed by a processor of the client device.

Referring still to FIG. 9, server 910 includes a data capture or input/output module 912, a communications module 914, a dynamic display generation or Graphical User Interface (“GUI”) module 916, a data module 918, and a data validation module 920.

Data module 918 is in further communication with a number of databases such as claim data database 930, employer data database 932, industry claim data database 934, and absence law and policy data database 936. The absence law and policy data database 936 might store, for example, information federal and state requirements associated with requests for accommodations. Databases may include both internal and/or external/third party databases. By way of example, external databases may include employer databases for access to employee data, and databases of individual leave management systems, such as workers' compensation administration systems and short term disability administration systems. Server 910 may be configured for bulk upload of data for leave management, such as data relating to individual claimants, such as name, address, birth date, service years, job description, type of claim, date of claim, description of claim, and dates of leave, from databases and spreadsheets on client device 952 to a database associated with the server. One or more modules may be configured to perform data validation steps prior to storing bulk uploaded data. Server 910 may further be configured to permit bulk download of data, such as claim data and analyses of claim data, to a client device.

In operation, server 910 is in communication with client devices, such as computer 952 or smartphone 954 via a network 950, which facilitates interaction with server 910, using, by way of example, one or more graphical user interfaces. As used herein, devices, such as client devices 952, 954 may exchange information via any communication network. Utilizing client devices 952, 954, an employer may initiate new claims for intake, review the status of claims, and upload reports and analyses. An employee may also use client devices 952, 954 to access server 910 and to obtain data concerning the employee's claims and documents related to the claims.

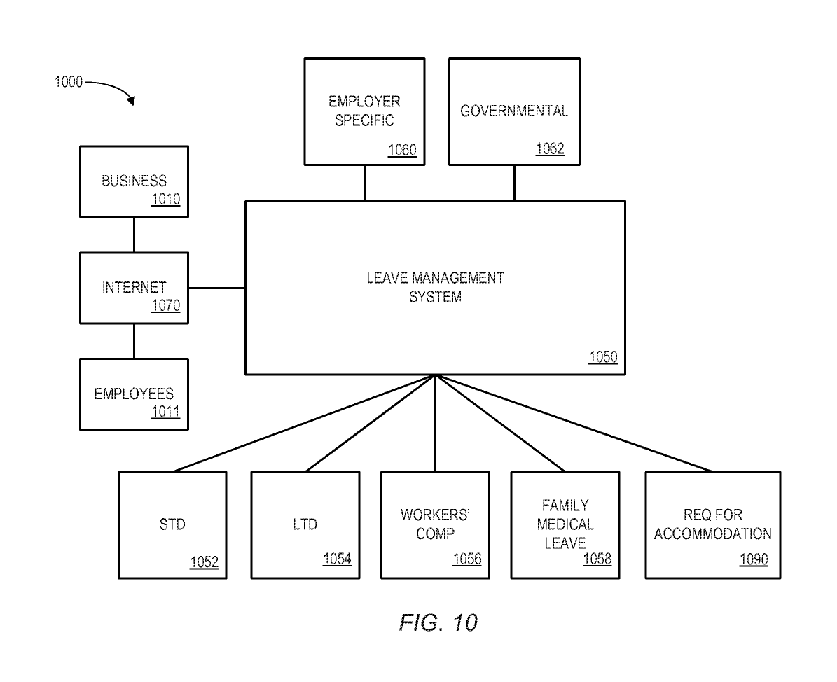

Referring to FIG. 10, a high level view 1000 of an environment for implementation of a method and system for comprehensive employee leave management is illustrated. Businesses 1010 of various types that have employees may include a retail store, a factory, and/or an office-based business 1030. Different businesses will each have varying rules for various types of employee requests for accommodation. Comprehensive leave management system server 1050 permits client devices operated by individual employers and officers and other representatives of the businesses, and employees of the businesses, to initiate claims for employee leave and requests for accommodations, to monitor the progress of claims, to receive requests for information from the system and from leave management specialists, and to obtain reports relating to employee claims. Comprehensive leave management system server 1050 provides a single point of contact for employees and managers relative to a variety of different types of claims, including short term disability 1052, long-term disability 1054, workers' compensation 1056, family medical leave 1058, employer-specific leave 1060, state-mandated leave 1062, and requests for accommodations 1090.

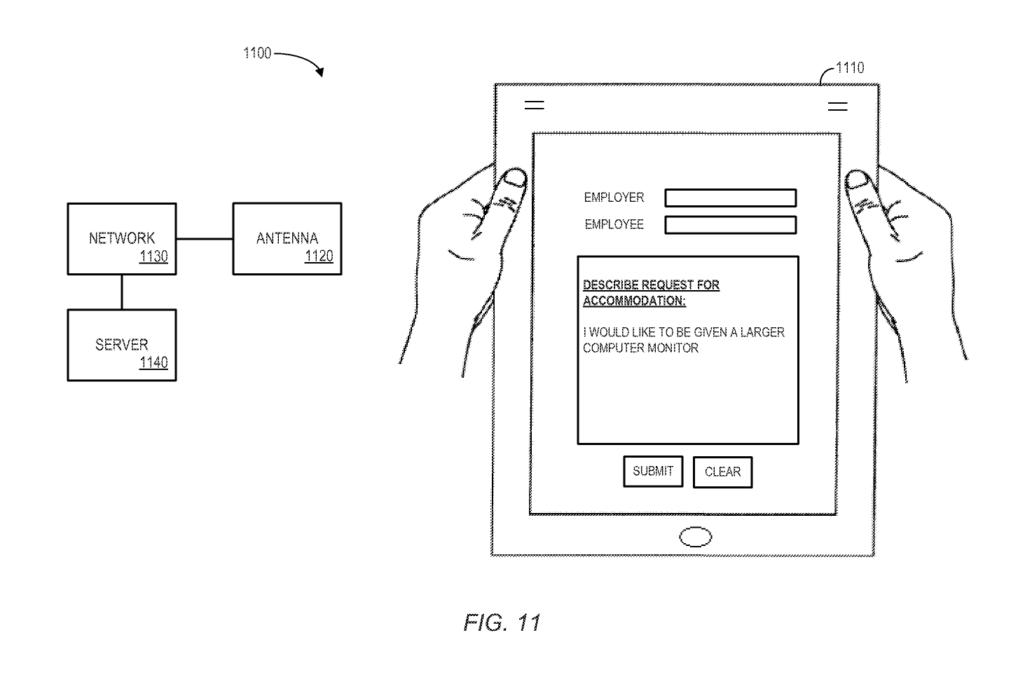

Referring now to FIG. 11, there is shown a system 1100 for administration of claims for employee leave and requests for accommodations. Hardware server 1140 is an exemplary computer system, such as an insurance company computer system. Hardware server 1140 may include a processor and devices in communication with the processor via a bus, the devices including data storage devices, communications devices, user interfaces, and other devices. Hardware server 1140 may be configured, such as through processor-executable instructions stored as program code in one or more of the data storage devices, to provide the functionality of a comprehensive leave management computer system. Hardware server 1140 is in communication, via network 1130, which may include one or more local area networks, wide area networks and interconnected networks (including the Internet), with a wireless communications network, represented by antenna 1120. The wireless communications network may be a wireless telephone communications network for transmission of voice and data to and from mobile wireless devices, such as smartphones and tablet computers. Handheld wireless communications device 1110 is in wireless communication with the wireless communications network via antenna 1120. Handheld wireless communications device 1110 may be any device capable of bidirectional wireless communications via cellular telephone networks, Wi-Ii devices, two-way radio, or any other form of wireless communications.

According to some embodiments, handheld wireless communications device 1110 may include a processor and memory device or memory devices in communication with the processor, as well as wireless antenna assemblies and one or more displays, such as touch screen displays, in communication with the processor. In an embodiment, a memory device of handheld wireless communications device 1110 has stored therein an application program including processor executable instructions for receiving submissions for claims for requests for accommodations and analyzing submitted claims for eligibility. The application program instructions, when executed by the processor of the device 1110, may cause the processor to provide an output to cause displays to prompt a user to enter information required to request an accommodation. The prompts may request information including the name and employer of the employee and a general reason for the requested accommodation. The device 1110 may display additional questions specific to the type of accommodation being requested by the employee.

In some embodiments, a memory device may have stored, as part of an application program, instructions which, when executed by the processor, cause the processor to determine whether the submitted information is sufficient for an eligibility determination to be made, before transmission of data indicative of the request for leave to server 1140. The memory device may have further stored, as part of the application program, instructions which, when executed by the processor, cause the processor to determine whether the claim is eligible before transmission of the information to server 1140. The instructions may further, when executed by the processor, cause the processor to provide a signal to the display to cause the display of the result of the determination. Thus, in an embodiment, a handheld wireless device 1110 may prompt the user for information sufficient for a complete request for accommodation via a display, receive via a user interface, such as a touch screen or keypad, data necessary for the determination, and determine, based on the received data and stored rules, whether the employee is eligible for the requested accommodation. The handheld wireless device 1110 may then generate a display having text and graphics that inform the user whether the accommodation is eligible, and provide information and documents setting forth the rights and responsibilities of the employee, depending upon the result of the determination. In some embodiments, one or more of these functions may be performed by a processor of the server 1140.

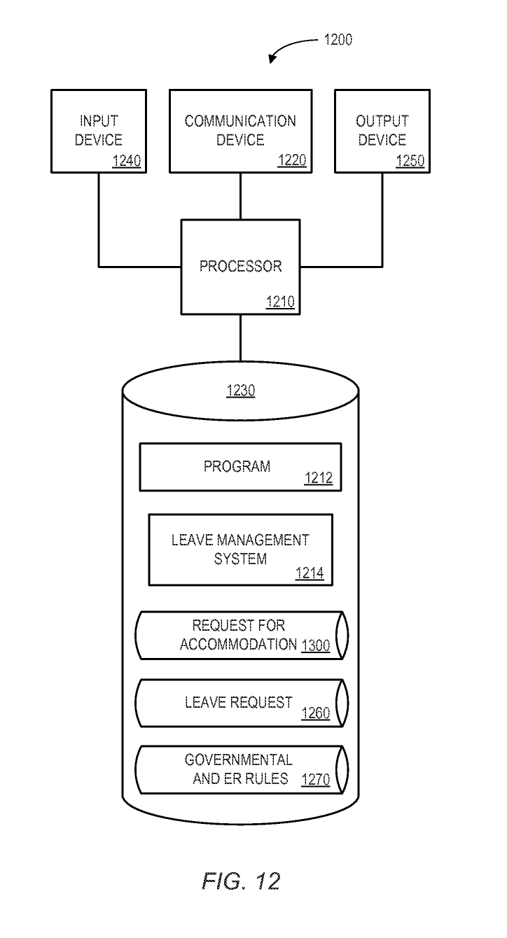

The embodiments described herein may be implemented using any number of different hardware configurations. For example, FIG. 12 illustrates a leave management system platform 1200 that may be, for example, associated with the system 100 of FIG. 1. The leave management system platform 1200 comprises a processor 1210, such as one or more commercially available Central Processing Units (CPUs) in the form of one-chip microprocessors, coupled to a communication device 1220 configured to communicate via a communication network (not shown in FIG. 12). The communication device 1220 may be used to communicate, for example, with one or more remote devices. The leave management system platform 1200 further includes an input device 1240 (e.g., a mouse and/or keyboard to enter and adjust request for accommodation data) and an output device 1250 (e.g., a computer monitor to display request for accommodation data).

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1212 and/or a leave management system application 1214 for controlling the processor 1210. The processor 1210 performs instructions of the programs 1212, 1214, and thereby operates in accordance with any of the embodiments described herein. For example, data received via a communication device 1220 indicative of employee claims, including employee claims for one of a plurality of types of employee leave, may be processed. The processor 1210 may then detect that a particular employee claim is associated with a request for accommodation. The processor 1210 may then automatically determine if medical information associated with the request for accommodation meets predetermined criteria (e.g., whether or not the medical information is sufficient and complete), and an indication of the determination may be transmitted.

The programs 1212, 1214 may be stored in a compressed, uncompiled and/or encrypted format. The programs 1212, 1214 may furthermore include other program elements, such as an operating system, clipboard application a database management system, and/or device drivers used by the processor 1210 to interface with peripheral devices.

As used herein, information may be “received” by or “transmitted” to, for example: (i) the leave management system platform 1200 from another device; or (ii) a software application or module within the leave management system platform 1200 from another software application, module, or any other source.

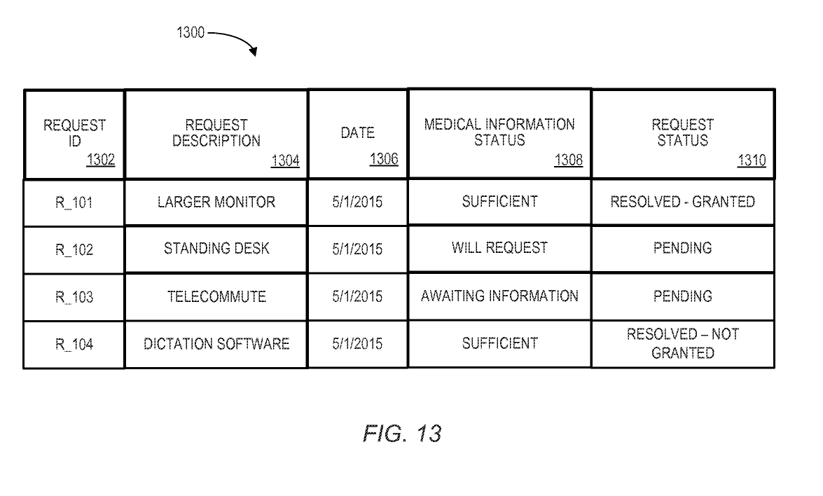

In some embodiments (such as shown in FIG. 12), the storage device 1230 further stores a request for accommodation database 1300, a leave request database 1260, and a governmental and employer rules database 1270. An example of a database that may be used in connection with the leave management system platform 1200 will now be described in detail with respect to FIG. 13. Note that the database described herein is only one example, and additional and/or different information may be stored therein. Moreover, various databases might be split or combined in accordance with any of the embodiments described herein. For example, the leave request database 1260 and the governmental and employer rules database 1270 might be combined and/or linked to each other within the program 1212 and/or leave management system application 1214.

Referring to FIG. 13, a table is shown that represents the request for accommodation database 1300 that may be stored at the leave management system platform 1200 according to some embodiments. The table may include, for example, entries identifying accommodation requests that have been submitted by employees. The table may also define fields 1302, 1304, 1306, 1308, 1310 for each of the entries. The fields 1302, 1304, 1306, 1308, 1310 may, according to some embodiments, specify: a request identifier 1302, a request description 1304, a date 1306, medical status information 1308, and a request status 1310. The request for accommodation database 1300 may be created and updated, for example, based on information received from employees, employers, physicians, etc.

The request identifier 1302 may be, for example, a unique alphanumeric code identifying an accommodation request that has been submitted by an employee. The request description 1304 may summarize and/or categorize the accommodation being requested (e.g., a standing desk or a larger display monitor) and the date 1306 may indicate when the employee submitted the request. The medical status information 1308 might indicate, for example, that the accommodation request is supported by sufficient medical documentation, that additional documentation has been or will be requested, or that the insurer or employee is waiting to receive additional records (e.g., from an attending physician). The request status 1310 might indicate that the employee's accommodation request has been resolved (granted or not granted) or that resolution is still pending.

Thus, embodiments described herein may provide systems and methods to facilitate the processing of employee requests for accommodations in an automated, efficient, and consistent manner.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with ADAAA requests for accommodations. Note, however, that other types of requests may also benefit from the invention. For example, embodiments of the present invention may be used in connection with requests associated with state or other governmental laws and regulations.

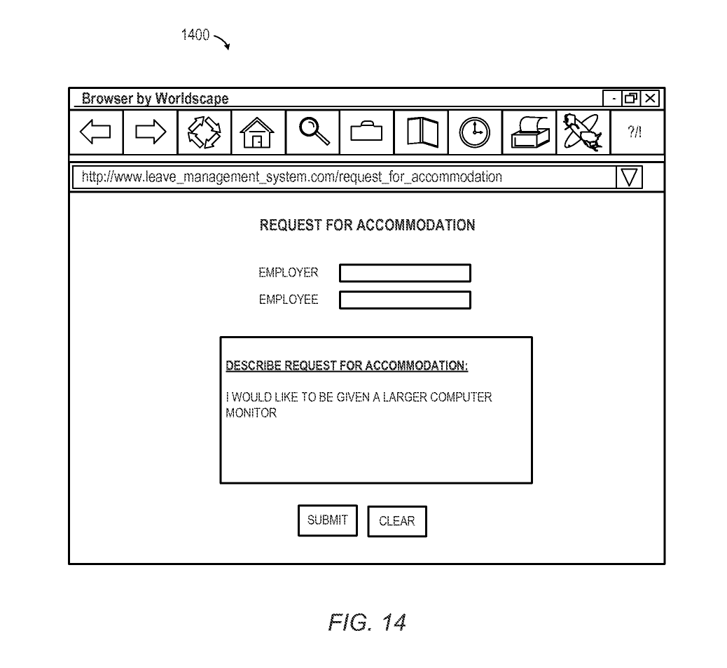

Moreover, some embodiments have been described herein as being accessed via a wireless device, such as a smartphone or tablet computer. Note, however, that embodiments may be implemented using any device capable of executing the disclosed functions and steps. For example, FIG. 14 illustrates a display 1400 in accordance with some embodiments described herein. In particular, the display 1400 includes a web browser that might be displayed by a PC including information associated with a leave management system platform.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system for facilitating processing of employee requests for accommodations, comprising:
a communication device to receive data;
a computer processor for executing program instructions; and
a memory, coupled to the computer processor, for storing program instructions for execution by the computer processor for:
processing, by a leave management system platform, data received via the communication device indicative of employee claims, including employee claims for one of a plurality of types of employee leave,
detecting, by the leave management system platform, that a particular employee claim is associated with a request for accommodation,
automatically determining if medical information associated with the request for accommodation meets predetermined criteria, and
transmitting an indication of said determination.

2. The system of claim 1, wherein the plurality of types of employee leave include: (i) workers' compensation leave, (ii) short term disability leave, and (iii) long term disability leave.

3. The system of claim 1, wherein the leave management system platform is associated with an insurer and the data indicative of the particular employee claim is received from an employer of the particular employee.

4. The system of claim 1, wherein the particular employee claim comprises a request for accommodation.

5. The system of claim 1, wherein the particular employee claim comprises a leave request and said detecting comprises determining that the leave request satisfies a predetermined rule.

6. The system of claim 5, wherein the predetermined rule is associated with an international classification of disease code associated with the leave request.

7. The system of claim 1, wherein the memory further stores program instructions for execution by the computer processor for:
analyzing the data indicative of employee claims, and
providing at least one report based on the analyzing, wherein the report includes at least one recommended accommodation related adjustment to a workplace environment.

8. The system of claim 1, wherein the automatic determination comprises automatically determining that medical information associated with the request for accommodation is insufficient, and the memory further stores program instructions for execution by the computer processor for:
automatically requesting additional medical information.

9. The system of claim 1, wherein the indication is transmitted to at least one of: (i) an ability analyst, (ii) an absence coordinator, (iii) an employee advocate, (iv) the particular employee, (v) an employer of the particular employee, (vi) a job accommodation network consultant, (vii) an account manager, (viii) a return to work coordinator, (ix) a loss control consultant, and (x) an attending physician.

10. A computer-implemented method of facilitating processing of employee requests for accommodations, comprising:
processing, by a computer processor of a leave management system platform, data received via a communication device indicative of employee claims, including employee claims for one of a plurality of types of employee leave;
detecting, by the computer processor, that a particular employee claim is associated with a request for accommodation;
automatically determining if medical information associated with the request for accommodation meets predetermined criteria; and
transmitting an indication of said determination.

11. The method of claim 10, wherein the plurality of types of employee leave include: (i) workers' compensation leave, (ii) short term disability leave, and (iii) long term disability leave.

12. The method of claim 10, wherein the leave management system platform is associated with an insurer and the data indicative of the particular employee claim is received from an employer of the particular employee.

13. The method of claim 10, wherein the particular employee claim comprises a request for accommodation.

14. The method of claim 10, wherein the particular employee claim comprises a leave request and said detecting comprises determining that the leave request satisfies a predetermined rule.

15. The method of claim 14, wherein the predetermined rule is associated with an international classification of disease code associated with the leave request.

16. The method of claim 1, further comprising:
analyzing the data indicative of employee claims; and
providing at least one report based on the analyzing, wherein the report includes at least one recommended accommodation related adjustment to a workplace environment.

17. A non-transitory, computer-readable medium storing instructions adapted to be executed by a computer processor to perform a method for facilitating processing of employee requests for accommodations, said method comprising:
processing data, received at a leave management system platform, indicative of employee claims, including employee claims for one of a plurality of types of employee leave;
detecting that a particular employee claim is associated with a request for accommodation;
automatically determining if medical information associated with the request for accommodation meets predetermined criteria; and
transmitting an indication of said determination.

18. The medium of claim 17, wherein the plurality of types of employee leave include: (i) workers' compensation leave, (ii) short term disability leave, and (iii) long term disability leave.

19. The medium of claim 17, wherein the leave management system platform is associated with an insurer and the data indicative of the particular employee claim is received from an employer of the particular employee.

20. The medium of claim 17, wherein the particular employee claim comprises a request for accommodation.

21. The medium of claim 17, wherein the particular employee claim comprises a leave request and said detecting comprises determining that the leave request satisfies a predetermined rule.

22. The medium of claim 21, wherein the predetermined rule is associated with an international classification of disease code associated with the leave request.

23. The medium of claim 17, wherein the method further comprising:
analyzing the data indicative of employee claims, and
providing at least one report based on the analyzing, wherein the report includes at least one recommended accommodation related adjustment to a workplace environment.
